(19) United States
(12) Patent Application Publication
(10) Pub. No.: US 2011/0157705 A1
(43) Pub. Date: Jun. 30, 2011

(54) SELF-DIMMING MIRROR IN A MOTOR VEHICLE

(75) Inventors: Heiko Bald, Modautal (DE); Aiko Boehme, Ingelheim (DE)

(73) Assignee: GM GLOBAL TECHNOLOGY OPERATIONS, INC., Detroit, MI (US)

(21) Appl. No.: 12/918,947

(22) PCT Filed: Mar. 26, 2008
(86) PCT No.: PCT/EP2008/002362

§ 371 Date: Feb. 24, 2011

(30) Foreign Application Priority Data
Apr. 12, 2007 (DE) 10 2007 017 170.8

(51) Int. Cl. B60R 1/08

(52) U.S. Cl. 359/604

(57) ABSTRACT

With a self-dimming mirror of a motor vehicle dimming can be automatically cancelled upon a change of a driving situation of the motor vehicle to increase road safety.

### CROSS-REFERENCE TO RELATED APPLICATIONS

This application is a U.S. National-Stage entry under 35 U.S.C. §371 based on International Application No. PCT/EP2008/002362, filed Mar. 26, 2008, which was published under PCT Article 21(2) and which claims priority to German Application No. 102007017170.8, filed Apr. 12, 2007, which are all hereby incorporated in their entirety by reference.

### TECHNICAL FIELD

The invention relates to a self-dimming mirror such as an inside or outside mirror of a motor vehicle.

### BACKGROUND

To avoid dazzling a driver of a motor vehicle it is known to more preferably pivot an inside mirror or its mirror surface so as not to directly reflect the light from the headlamps of a following road user entering the inside mirror in the direction of the driver's eyes. If this does not take place, the driver can be dazzled as a result of which he no longer clearly sees the traffic around him particularly in darkness.

Furthermore it is known to design an inside mirror in a self-dimming manner. Among other things, this can be effected with electrochromatic effects such as are known from EP 0 758 929 A1. To this end, the light entering the inside mirror is measured with an optical sensor with respect to the intensity and as soon as dimming is deemed necessary by control device the mirror is dimmed with the help of the electrochromatic effect and the reflected quantity of light thus reduced. This more preferably takes place automatically in order to increase the driving comfort.

If additional dazzling does not occur, dimming can also be cancelled again automatically.

However, it is seen as a disadvantage here that under certain conditions despite a following road user and consequently dimmed mirror exact monitoring of the rearward traffic may be necessary in order to avoid overlooking potential safety hazards.

It is at least one object of the invention to create a self-dimming mirror of the type mentioned at the outset which leads to an increase of road safety and with which driving comfort is improved. In addition, other objects, desirable features, and characteristics will become apparent from the subsequent detailed description, and the appended claims, and this background.

### SUMMARY

An apparatus of a motor vehicle is provided that includes, but is not limited to a self-dimming mirror, a detection device adapted to detect a change in a driving situation of the motor vehicle, a control unit adapted to receive the change in the driving situation of the motor vehicle from the detection device and control the self-dimming mirror such that a dimming of self-dimming the mirror is automatically cancelled upon the change of the driving situation of the motor vehicle.

In accordance with embodiment, the driving situation can be any number of driving situations, including, but not limited to a hazard situation actuation of a driving direction indicator and/or severe acceleration and/or braking and/or activation of a fog headlamp and/or activation of a hazard warning flasher and/or switching-off of a low-beam or driving light and/or activation of a rear screen heater. The driving situation can also include, but is not limited to, approaching of an intersection and/or a turn-off and/or actuation of a severe acceleration, and/or braking, and/or activation of a fog headlamp and/or activation of a hazard warning flasher and/or switching-off of a low-beam and/or switching-off of a driving light.

In accordance with embodiments, the detection device can be any number of devices, such a sensor, such as a distance sensor and/or the sensor can be a radar device.

In accordance with embodiments, the self-dimming mirror can be a mechanical mirror and the apparatus can further include, but not limited to an electric motor adapted to reset to the mechanical mirror to an original starting position. The self-dimming mirror can be an interior mirror and the interior mirror can be arranged in a central upper area of an interior of the motor vehicle. Alternatively, the self-dimming mirror is an exterior mirror in accordance with an alternate embodiment.

In accordance with another embodiment, the control unit is further adapted to control a second self dimming mirror independent of the self-dimming mirror.

### DETAILED DESCRIPTION

The following detailed description is merely exemplary in nature and is not intended to limit application and uses. Furthermore, there is no intention to be bound by any theory presented herein or the following detailed description.

According to an embodiment the invention, the at least one object, other objects, desirable features, and characteristic, are solved in that dimming of the mirror can be automatically cancelled upon a change of a driving situation of the motor vehicle.

With a mirror of a motor vehicle designed in this manner in principle any change of the driving situation of the motor vehicle will directly lead to dimming being cancelled. To this end, an electrochromatic mirror can be activated in such a manner that dimming is reversed again. In principle, a mechanical mirror which is for example pivoted with an electric motor can be reset to its original starting position by said electric motor. Obviously this includes an inside mirror, which is usually arranged in a central upper area of the interior of the motor vehicle, as well as one or both outside mirrors of the motor vehicle. In this case, dimming of a plurality of mirrors can also be cancelled again independently of one another.

In principle, it is also possible to only partially cancel dimming, if for example the light intensity of the headlamps of the following road user is too high, dimming is only reduced by half so as not to dazzle the driver too severely. This can be determined and controlled with an already available optical sensor.

Now as before, the driver can still cancel dimming as he wishes, e.g. by actuating a suitable actuation element.

At least one advantage of the embodiments of the is that during the manufacture of the motor vehicle or the mirror hardly any additional expenditure accrues since all components, sensors and control installations are already present and interlinked in the motor vehicle and a central control unit for example merely needs to be configured in terms of hardware and/or software so that when a changed driving situation is detected the already existing mirror is suitably activated.

In an advantageous configuration dimming is cancelled upon automatic detection of a hazard situation in order to afford the driver optimum all round vision. This automatic detection of hazard situations can be effected with known systems for monitoring the surroundings of the motor vehicle among other things with distance sensors, radar devices and the like. If such a hazard situation is detected, the motor vehicle can automatically set the backrests in upright position, tension the safety belts and if applicable already generate slight braking action. In addition, a dimmed mirror is now restored to bright again.

Additional information with respect to a change of a driving situation can be gleaned among other things by actuating a driving direction indicator. If the motor vehicle for example travels on a multi-lane road in darkness and a further road user follows, the outside and/or inside mirror can be restored to bright again when the driving direction indicator is actuated prior to a change of lane in order to be thus able to see the rearward area of the neighboring lane to be changed into. Similarly, a mirror can be restored to bright again during a major acceleration operation, in the case of an automatic transmission also during kick-down acceleration, which normally takes place prior to an overtaking maneuver, likewise during a braking operation. Furthermore, the mirror can be restored to bright when a fog lamp on the vehicle front and/or rear is switched on since in fog poorer visual conditions are present anyhow, which should not be additionally restricted through dimming. Furthermore, activation of a hazard warning flasher indicates a changed driving situation. Finally dimming can be cancelled if a low-beam or driving light, i.e. in brightness, is manually or automatically switched off, likewise if a rear screen heater is activated, which frequently takes place only with misting-up rear screen, which only allows poorer visual conditions.

According to a further embodiment dimming can be cancelled again on approaching an intersection and/or a turn-off point. Such approach can be determined with a navigation system or its GPS receiver already present in the motor vehicle or with visual sensor systems for more preferably monitoring the lane edges. In an intersection and/or turning-off area it is necessary that all areas around the motor vehicle can be seen, that is also the rearward areas via the inside and outside mirrors. If the navigation system has detected that a change to a turn-off lane is intended at a turn-off point for example, dimming of the appropriate outside mirror can be timely cancelled again in advance in order to be able to completely monitor this turn-off lane when negotiating the latter.

It is to be understood that the features mentioned above cannot only be used in the respective combination stated, but also in other combinations. The scope of the invention is only defined by the claims.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. An apparatus of a motor vehicle, comprising:
a self-dimming mirror;
a detection device adapted to detect a change in a driving situation of the motor vehicle;
a control unit adapted to receive the change in the driving situation of the motor vehicle from the detection device and control the self-dimming mirror such that a dimming of self-dimming the mirror is cancelled upon the change of the driving situation of the motor vehicle.

2. The apparatus according to claim 1, wherein the driving situation is a hazard situation.

3. The apparatus according to claim 1, wherein the driving situation is actuation of a driving direction indicator.

4. The apparatus according to claim 1, wherein the driving situation is approach of an intersection.

5. The apparatus according to claim 1, wherein the driving situation is actuation of a severe acceleration.

6. The apparatus according to claim 1, wherein the driving situation is a braking.

7. The apparatus according to claim 1, wherein the driving situation is activation of a fog headlamp.

8. The apparatus according to claim 1, wherein the driving situation is activation of a hazard warning flasher.

9. The apparatus according to claim 1, wherein the driving situation is switching-off of a low-beam.

10. The apparatus according to claim 1, wherein the driving situation is switching-off of a driving light.

11. The apparatus according to claim 1, wherein the detection device is a sensor.

12. The apparatus according to claim 11, wherein the sensor is a distance sensor.

13. The apparatus according to claim 1, wherein the detection device is a radar device.

14. The apparatus according to claim 1, wherein the self-dimming mirror is a mechanical mirror and the apparatus further comprises an electric motor adapted to reset to the mechanical mirror to an original starting position.

15. The apparatus according to claim 1, wherein the self-dimming mirror is an interior mirror.

16. The apparatus according to claim 15, wherein the interior mirror is arranged in a central upper area of an interior of the motor vehicle.

17. The apparatus according to claim 1, wherein the self-dimming mirror is an exterior mirror.

18. The apparatus according to claim 1, wherein the control unit is further adapted to control a second self dimming mirror independent of the self-dimming mirror.

19. The apparatus according to claim 1, wherein driving situation is an activation of a rear screen heater.

20. The apparatus according to the claim 1, wherein the driving situation is an approach of a turn-off.
